(19) United States
(12) Patent Application Publication
(10) Pub. No.: US 2004/0265455 A1
(43) Pub. Date: Dec. 30, 2004

(54) Extrusion apparatus

(76) Inventors: Martyn Thomas Wray, Stamford (GB); Ian Peter Lilley, Peterborough (GB)

Correspondence Address: John P White, Cooper & Dunham, 1185 Avenue of the Americas, New York, NY, 10036, US

(21) Appl. No.: 10/485,938

(22) PCT Filed: Aug. 2, 2002
(86) PCT No.: PCT/GB02/03584

(30) Foreign Application Priority Data
Aug. 4, 2001 (GB) 0119122.0
Jan. 8, 2002 (GB) 0200280.6

(51) Int. Cl. A01J 1/00

(52) U.S. Cl. 426/516

(57) ABSTRACT

Apparatus and method for producing an extruded product (and in particular a food product) comprising a plurality of intertwined or plaited extruded strands (140, 141, 142). The apparatus for producing a plurality of intertwined extruded strands (140, 141, 142), comprising first (4), second (5) and third (6) extrusion die bodies, a first rotor (2), a second rotor (3), and a stator (7) in which the rotors are rotatably mounted about substantially parallel respective axes, and the arrangement being such that in use one of the rotors is caused to rotate and in so doing engages with two of the die bodies to rotate said two die bodies about the axis of said one rotor, and rotation of the other rotor similarly causes two of the die bodies to be rotated about the axis of that other rotor, and in which each die body is provided with a conduit (28, 28′, 28″), and each conduit comprises an inlet (41, 43) and an outlet (110, 111, 112), the inlets of the conduits being axially spaced from one another in the direction of the axes of the rotors, and said inlets being in communication with respective supply chambers (100, 101). Advantageously the inventive apparatus is capable of forming a multi-strand product in which each strand is formed from a particular material.

The present invention relates to extrusion apparatus for producing a product comprising a plurality of intertwined strands and in particular, but not exclusively, a food product comprising a plurality of intertwined strands of food material.

It is known that food products, for example a baked or confectionery item, having a braided or plaited appearance are attractive to consumers. We have realised that it would be desirable to be able to industrially produce a food product which comprises intertwined strands comprising the same or different materials, for example a food product comprising three intertwined strands, of which a first strand comprising a first material, a second strand comprising a second material and a third strand comprising a third material.

According to a first aspect of the invention there is provided apparatus for producing a plurality of intertwined extruded strands, comprising first, second and third extrusion die bodies, a first rotor and a second rotor, and a stator in which the rotors are rotatably mounted about substantially parallel respective axes, and the arrangement being such that in use one of the rotors is caused to rotate and in so doing engages with two of the die bodies to rotate said two die bodies about the axis of said one rotor, and rotation of the other rotor similarly causes two of the die bodies to be rotated about the axis of that other rotor, and in which each die body is provided with a conduit, and each conduit comprises an inlet and an outlet, the inlets of the conduits being axially spaced from one another in the direction of the axes of the rotors, and said inlets being in communication with respective supply chambers.

Advantageously, since the inlets are axially spaced, the supply chambers can be arranged so that material in one chamber which feeds one of the inlets is separate from material in a chamber which feeds another of the inlets and vice versa, thus avoiding contamination from one chamber to another. This makes it possible to extrude different materials from the different die bodies to create the different strands.

In one embodiment of the invention the rotors are operative to sequentially rotate two of the die bodies through 180° at a time to produce an intertwined product, one of the die bodies, that has just been rotated through 180° by one rotor, then being captured by the other rotor for rotation through 180° by that other rotor, whereby the die body is caused to execute a figure-of-eight path relative to the stator.

The chambers are preferably separated from one another so as to substantially prevent material entering one chamber from the other chamber.

Most preferably the chambers are axially spaced with respect to the axis of rotation of the rotors.

The chambers are preferably defined by surfaces of the stator, the die bodies and the rotors.

The die bodies and the rotors are preferably of generally elongate form, and aligned surface portions of the die bodies, the rotors and the stator define the three axially spaced chambers.

The apparatus preferably comprises a partition which axially separates one chamber from an adjacent chamber. The apparatus most desirably comprises a plurality of such partitions.

The outlets are preferably substantially diametrically located about the axis of rotation of a respective rotor.

In order to enable the production of a strand which itself comprises two streams of different materials, at least one of the die bodies is preferably provided with a second conduit inlet and a second conduit outlet, the second conduit outlet being arranged in or adjacent to the outlet of said conduit whereby in use a co-extruded strand of material issues from said co-arranged outlets, said second conduit inlet communicating with a second conduit chamber.

Preferably said conduit outlet is surrounded by said second conduit outlet whereby the material from said second conduit chamber encases material flowing from said conduit, in the co-extruded strand. This is particularly suitable for a baked product where the encasing material can be a dough-based material, such as biscuit dough.

It will be appreciated that sugar-based confectionery material could be used to form an intertwined extrudate.

Preferably each die body is provided with a respective inlet communicating with said second conduit chamber, whereby co-extruded strands of material can be extruded by each die body, and the encasing material for each strand is supplied from the common second conduit chamber.

In order to enable the production of a strand which itself comprises streams of three different materials, at least one of the die bodies is preferably provided with second and third conduits in addition to said conduit, and the outlets of the three conduits are co-arranged, either adjacent to one another or one within another.

Preferably the three outlets of the three conduits are substantially circular outlets and are arranged substantially co-axially of one another, whereby a strand can be produced which is made up of a central core encased by concentric annular layers of two different materials.

The inlets to the first, second and third conduits preferably communicate with respective chambers that are disposed at different axial positions from one another.

Although said chambers will usually be supplied with different materials in order to produce strands comprising streams of the different materials, it will be appreciated that the same material may, if desired, be supplied to different chambers when a less complex product is required to be produced.

The die bodies are preferably of a substantially lenticular transverse cross-sectional profile, the rotors being provided with recesses of complementary cross-section to accommodate the die bodies, and the curvatures of the lens faces of the die bodies corresponding substantially to the curvature of the cylindrical surfaces of the rotors.

The rotors may be of a substantially biconcave transverse cross-sectional profile.

The process preferably comprises subjecting the intertwined strands to a baking procedure.

According to a second aspect of the invention there is provided an intertwined extruded product which is produced by the apparatus in accordance with the first aspect of the invention.

One preferred product comprises three intertwined strands and each strand comprises two co-axial streams of material, and the outer layer of material of each strand is a baked dough-based material, such as biscuit dough. The inner layer may be, for example, yoghurt or fruit paste.

Embodiments of the invention will now be described, by way of example only, with reference to the accompanying drawings in which:

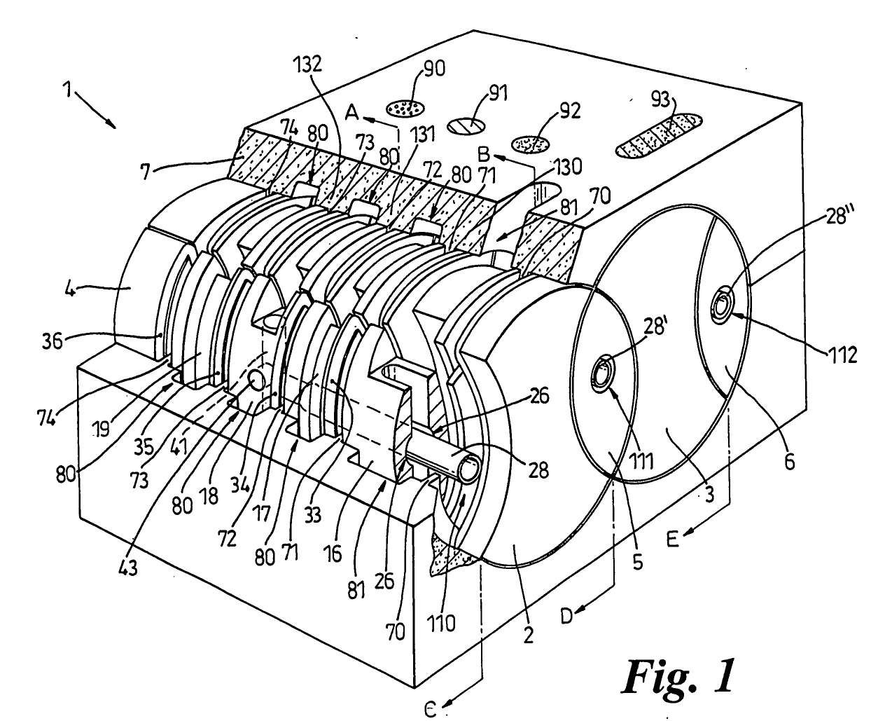

FIG. 1 is a schematic perspective view of an extrusion apparatus, in which part of the stator and a die body has been omitted for purposes of illustration,

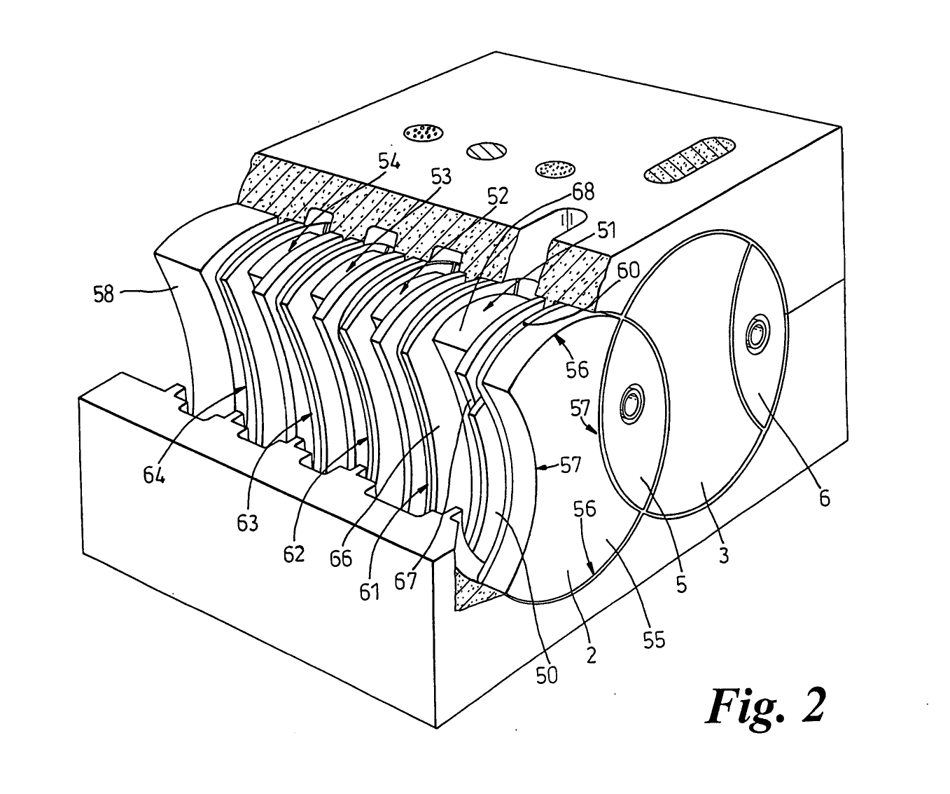

FIG. 2 is a schematic perspective view of the extrusion apparatus identical to that shown in FIG. 1 except that a die body has been omitted,

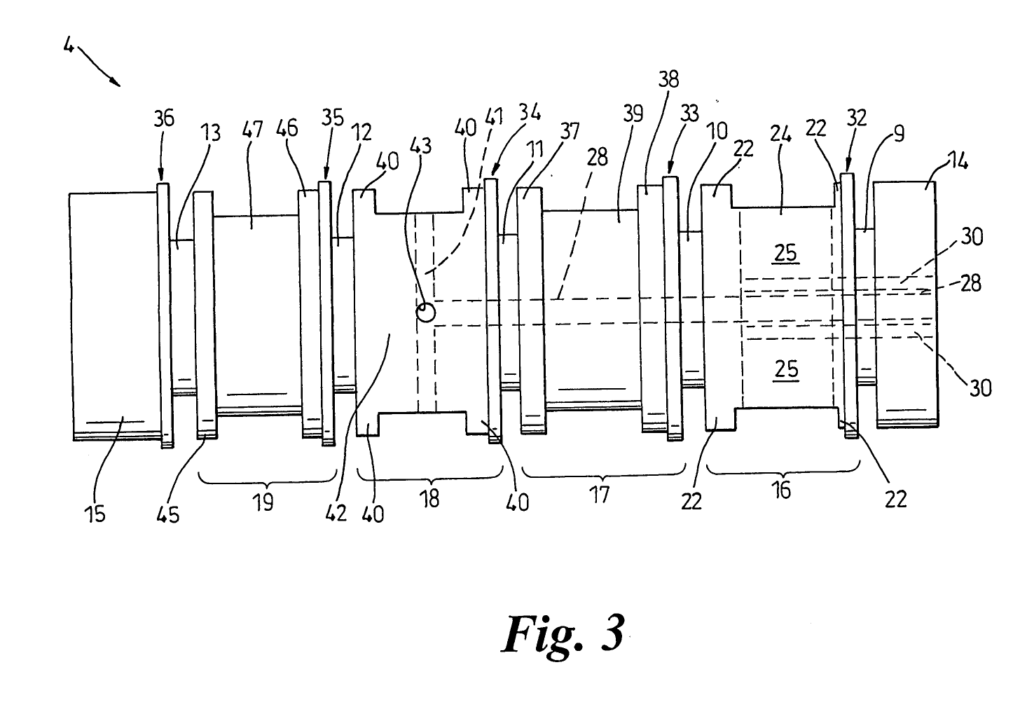

FIG. 3 is a side elevation of the die body which is omitted in FIG. 2,

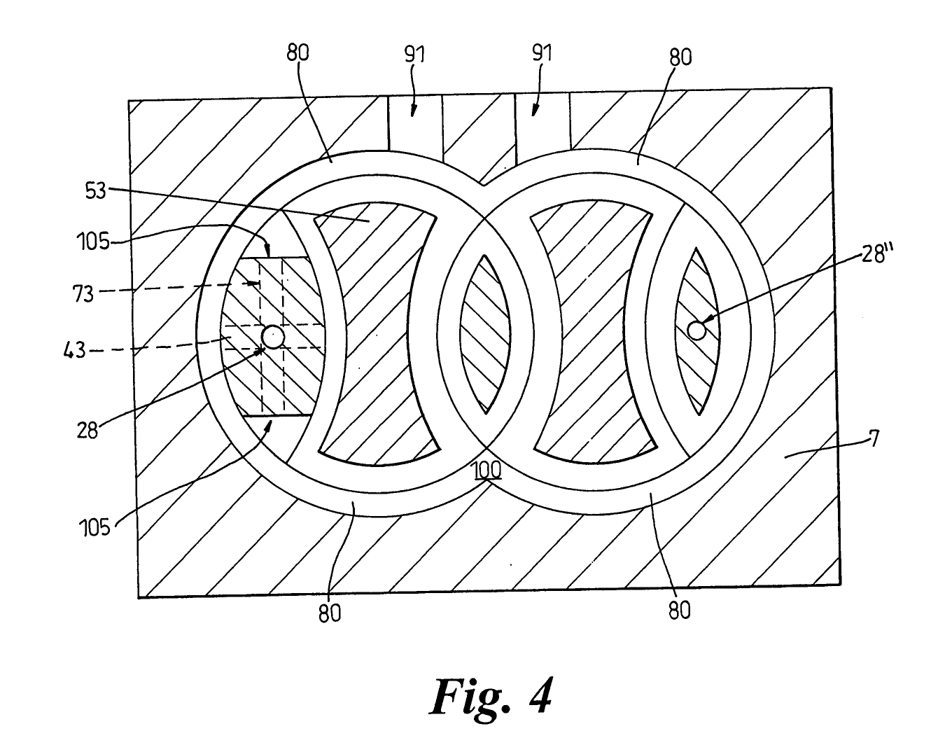

FIG. 4 is a schematic cross-sectional view of the apparatus shown in FIG. 1 on section A,

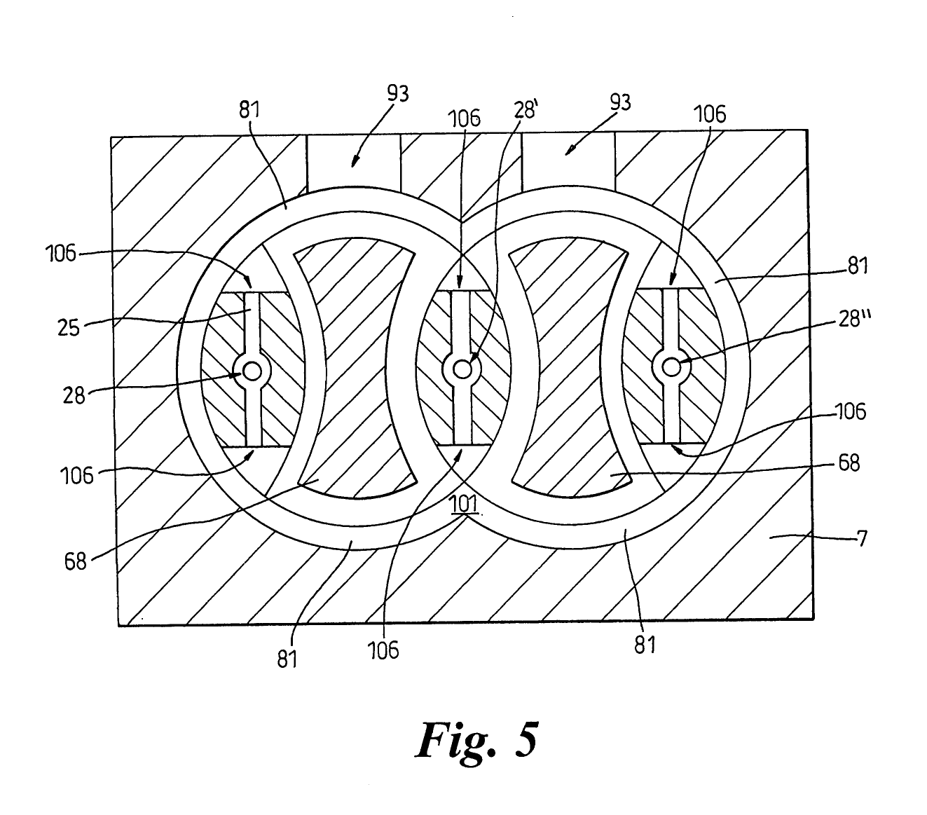

FIG. 5 is a schematic cross-sectional view of the apparatus shown in FIG. 1 on section B,

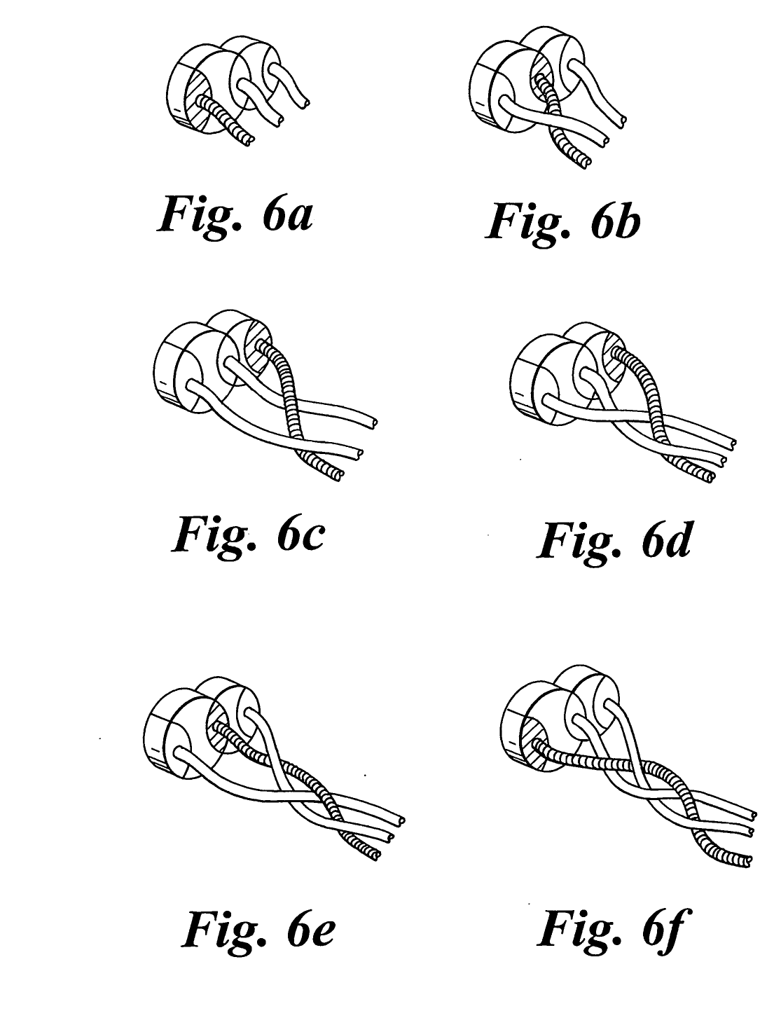

FIGS. 6a-6f are schematic ‘snap-shots’ of the apparatus shown in FIG. 1 producing a multi-strand intertwined product,

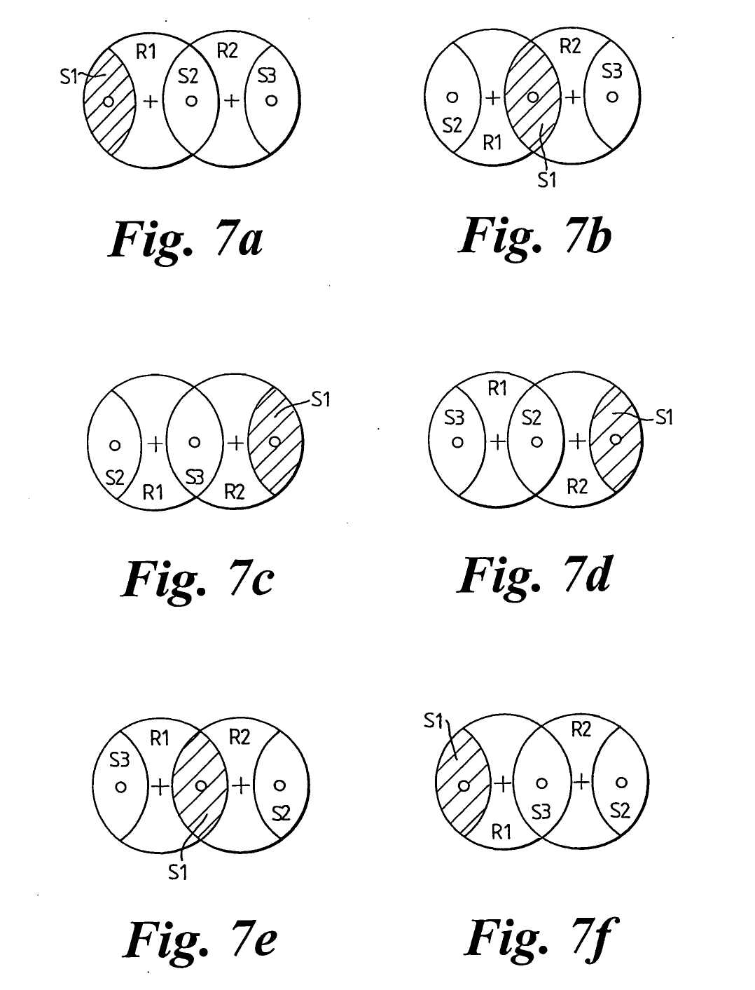

FIGS. 7a-7f are schematic representations of the locations of the die bodies corresponding to each snap-shot shown in FIGS. 6a-6f respectively,

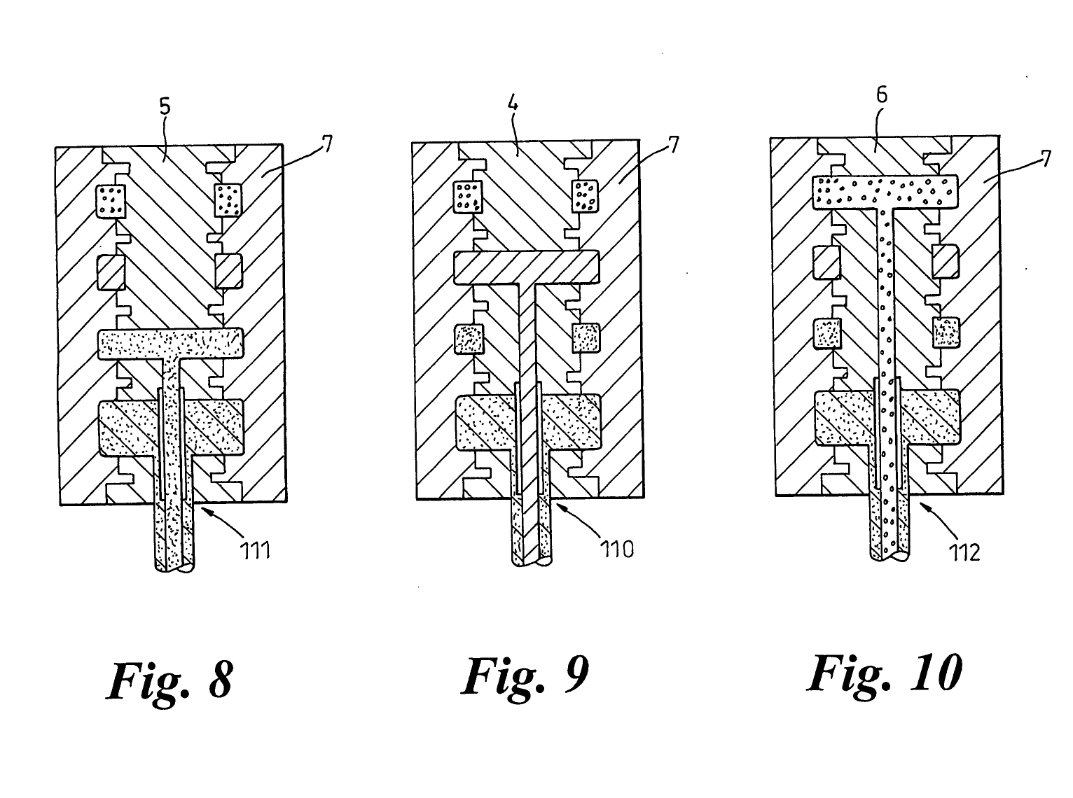

FIG. 8 is a schematic cross-sectional view on section C,

FIG. 9 is a schematic cross-sectional view on section D,

FIG. 10 is a schematic cross-sectional view on section E,

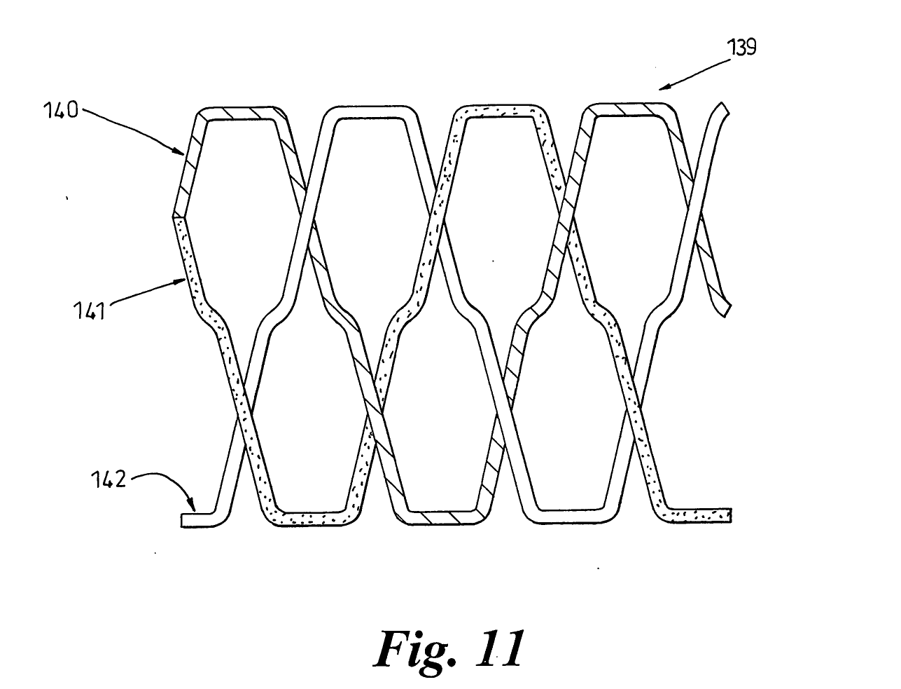

FIG. 11 is an illustration of an intertwined multi-strand product produced by the apparatus in FIG. 1,

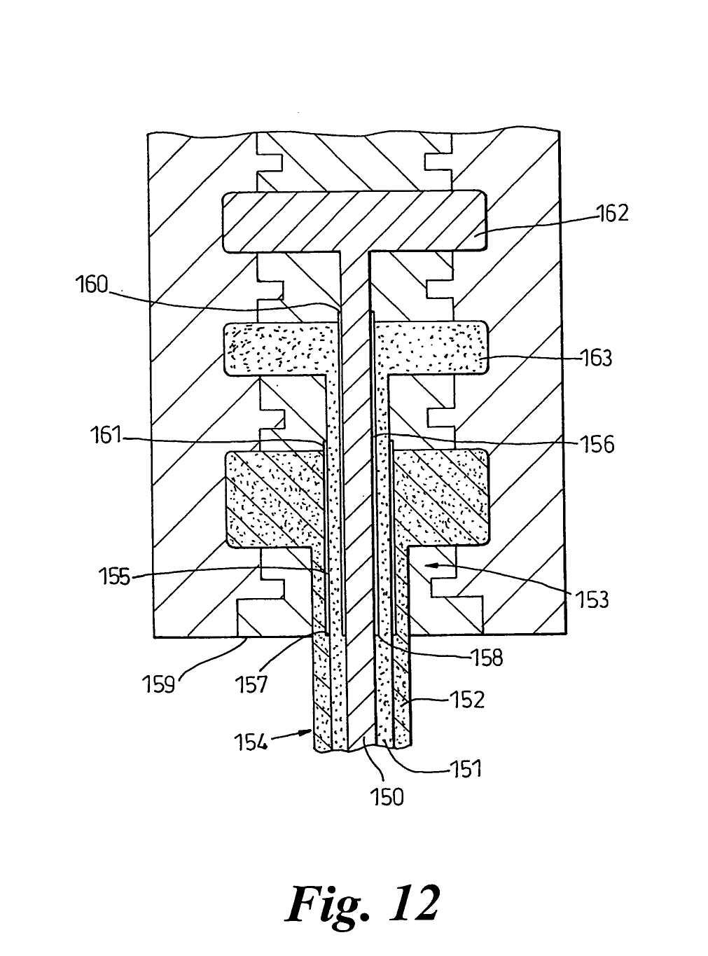

FIG. 12 is a view similar to FIG. 8 but of a modification in which a die body is provided with two co-axial conduits, and

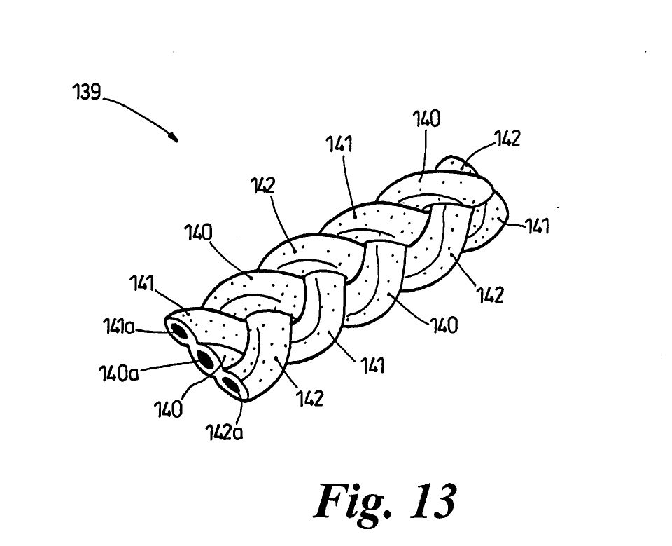

FIG. 13 is a perspective view of a multi-strand intertwined product produced by the apparatus shown in FIG. 1.

FIG. 1 shows apparatus 1 for producing an intertwined extruded product, the apparatus comprising two rotors 2 and 3 and three die bodies 4, 5 and 6, the rotors being operative to rotate the die bodies in a stator 7 about the axes of rotors 2, 3.

The die body 4 is of generally elongate form and has a transverse cross-sectional profile which is substantially lenticular. With reference in particular to FIG. 1 and FIG. 3, the die body comprises five intermediate portions 9, 10, 11, 12 and 13, a front portion 14, a rear portion 15 and four chamber sections 16, 17, 18, 19. The intermediate portions 9, 10, 11, 12 and 13 have a transverse cross-sectional profile which is substantially lenticular and are of smaller dimensions than those of the front and back portions 14 and 15 and the chamber sections 16, 17, 18 and 19. The intermediate portions 9 and 13 are located between the front portion and the chamber portion 16, and between the back portion 15 and the chamber portion 19 respectively. The intermediate portions 10, 11 and 12 are situated between the chamber portions 16 and 17, 17 and 18, and 18 and 19 respectively.

The chamber section 16 is of convex profile and comprises four outer portions 22 and a central portion 24. The central portion 24 has formed therein a recessed region 25 which extends through the height of the central portion 24. Two curved wall portions 26 which partially define the recessed region 25 are provided to accommodate a conduit 28 which passes through the recessed region 25. The wall portions 26 are radially spaced from the conduit 28.

The intermediate portion 9 and the front portion 14 are provided with a bore 30 which is concentric with the curved wall portions 26 and the bore 30 accommodating the conduit 28.

A seal 32 is provided which extends around the perimeter of the chamber portion 16.

The chamber section 17 comprises two outer portions 37 and 38 and a central portion 39. The two outer portions and the inner portion are of lenticular cross-sectional profile, and the central portion 39 being of smaller dimensions than those of the outer portions. The outer portion 38 is provided with a seal 33 which extends around the perimeter thereof.

The chamber section 18 comprises four outer portions 40 and a central portion 42. The central portion 42 is provided with a central open bore 41 which extends through the height of the central portion 42, and at the same axial location two lateral bores 43 which extend through the central portion perpendicular to the open bore 41.

The conduit 28 axially extends through the die body and connects with the mid-position of the bore 41.

A seal 34 is provided around the chamber section 18.

The chamber section 19 is substantially identical to the chamber section 17 and comprises two outer portions 45 and 46, and a central portion 47, a seal 35 being provided around the perimeter of the outer section 46.

The rear portion 15 is provided with a seal 36 which extends around the perimeter thereof.

The die bodies 5 and 6 are substantially identical to the die body 4, conduits similar to conduit 28 being provided therein which are connected to open bores (identical to bore 41) in respective chamber sections of the die bodies. However inlets to the open bores are provided at different respective axial positions in the direction of the axes of rotation of the rotors 2 and 3, as will become more readily apparent in the discussion below.

FIG. 2 more fully illustrates the construction of the rotor 2. The rotor 2 is of elongate form and may be described generally as having a biconcave transverse cross-sectional profile. More particularly the rotor 2 comprises five intermediate portions (of which intermediate portion 50 is shown in FIG. 2), and four chambers sections 51, 52, 53 and 54, a front portion 55 and a rear portion 58.

The front portion 55 has a biconcave profile which is made up of four arcuate portions of the same radius, namely two arcuate portions 56 and two arcuate portions 57. The front portion 55 is provided with a seal 60 which extends around a perimeter of the portion 55.

The chamber section 51 comprises two axially spaced outer portions 66 and 67 and a central portion 68. The central portion 68 is of lesser dimensions than those of the outer portions 66 and 67 but is nevertheless of a similar shape to that of the front portion. The outer portion 66 is provided with a seal 61 which extends around the perimeter thereof.

The remaining chamber sections 52, 53 and 54 are substantially identical to the chamber section 51 in that they each comprise two outer portions and a central portion, the central portion being of smaller dimensions than the outer portions, and one of each pair of outer portions is provided with a seal 62, 63 and 64 respectively, however the axial length of the central portion 68 is greater than those of the central portions of the chamber sections 52, 53 and 54.

The rotor 3 is identical to the rotor 4 and therefore needs no further explanation.

Returning to FIG. 1 it will be seen that the die bodies 4, 5 and 6 are received by the rotors 2 and 3, and are located in two part-circular (overlapping) spaces in the stator 7.

The stator 7 is provided with five guides 70, 71, 72, 73 and 74, each comprising two juxtaposed part-annular guide portions (corresponding to each part-circular space), each guide portion being provided to allow for the rotation of each rotor 2 and 3 and the die bodies.

The guides are accommodated in axially aligned annular spaces defined by the die bodies and the respective rotor. For example, a part-annular space is defined between the chamber section 16 and the chamber section 17 of the die body 4, which is aligned with two part-annular spaces which are defined between the chamber section 51 and the chamber section 52 of the rotor 2. Those annular spaces are aligned with a part-annular space defined by the die body 5 between two chamber sections as for the die body 4. Exactly the same considerations apply to an aligned annular space which is formed by the rotor 3 and the die bodies 5 and 6, and also for the other axially spaced annular spaces which are defined by the rotors and the die bodies to accommodate the other part-annular guide portion of the stator 7.

The stator 7 further comprises four pairs of axially aligned part-annular channels 80 and 81, as best shown in FIGS. 4 and 5. Interposed between the recesses there are provided annular walls 130, 131 and 132. The upper section of the stator 7 is provided with eight inlets 90, 91, 92 and 93 which are in communication with respective part-annular channels 80 and 81.

The apparatus operates as follows. A different food material is fed into each of the inlets 90, 91, 92 and 93. More specifically a first food filling material is fed into inlets 90, a second food filling material is fed into inlets 91, a third food filling material is fed into inlets 92, and a particular food outer material is fed into inlets 93. In so doing axially spaced chambers which are defined by the rotors, the die bodies and the stator are filled. By way of example, the chambers 100 and 101 which are fed through inlets 91 and 93 respectively (see FIGS. 4 and 5) will be considered. With reference to FIG. 4 the chamber is defined by the two part-annular channels 80, axially aligned central portions of the chamber sections of each die body and the rotors. Similarly with reference to FIG. 5, the chamber is defined by the part-annular recesses 81, and the axially aligned central portions of the die bodies and the rotors.

The chambers which are fed with the first and third filling materials through inlets 90 and 92 into respective chambers which are identical to chamber 100 shown in FIG. 4, with the exception that the inlet to a conduit will be provided in die bodies 6 and 5 respectively.

As material is pumped into the chamber 100 the chamber will fill and material is eventually urged into inlets 105 of the open bore 73 and is urged through the conduit 28. Exactly the same process occurs in the other chambers which are filled with the two other filling materials.

With regard to the chamber 101, outer material (for example a dough) fills the chamber and material is eventually urged through the inlets 106 which are provided in each of the die bodies. The material is thus urged through the annular space around each conduit 28, 28′ and 28″.

Thus through outlets 110, 111 and 112 of the apparatus 1 there is produced three extruded strands each comprising a ‘core’ of the respective filling material and an outer ‘casing’ of outer material, as illustrated in FIGS. 8, 9 and 10. It will be appreciated however that not all of the strands need be provided with an outer material and modified versions of the apparatus 1 may not have all three core material outlets provided with a casing material outlet.

The outer sections of each chamber section and the dividing walls 130, 131, 132 form partitions between the axially spaced chambers to prevent material from one chamber contaminating material in another chamber.

In order to produce an intertwined product the rotors 2 and 3 need to be activated in a particular sequence which will now be described with reference to FIGS. 6a-6f and FIGS. 7a-7f. In FIGS. 7a-7f the rotors 2 and 3 and the die bodies 4, 5 and 6 are referenced as R1, R2, S1, S2 and S3 respectively so as to indicate both identity and orientation. The die body S1 and the strand exiting therefrom are shaded in FIGS. 6a-6f and 7a-7f.

FIGS. 6a and 7a show the apparatus 1 in the condition shown in FIG. 1 with extruded strands being produced onto a conveyor (not illustrated). The rotor R1 is first rotated through 180° anti-clockwise and in so doing the die bodies S1 and S2 are rotated through 180° anti-clockwise to achieve the condition shown in FIGS. 6b and 7b. The rotor R2 then rotates the die bodies S1 and S3 180° clockwise to achieve the condition shown in FIGS. 6c and 7c. The rotor R1 then rotates the die bodies S2 and S3 anti-clockwise through 180° to achieve the condition shown in FIGS. 6d and 7d. The rotor R2 then rotates the die bodies S1 and S2 through 180° clockwise to the condition shown in FIGS. 6e and 7e. The rotor R1 is then rotated 180° anti-clockwise to rotate S3 and S1 through 180° to the condition shown in FIGS. 6f and 7f.

FIG. 11 shows, schematically, a three-strand product comprising three strands 140, 141 and 142 which is produced by the apparatus 1 when the sequence rotation of the rotors as described above is continued.

FIG. 13 shows the product 139 which shows each strand 140, 141 and 142 having a respective core 140a, 141a and 142a.

FIG. 12 shows a modified construction of die body 153 which is able to produce an extruded-strand product in which at least one strand comprises three co-axial layers or streams of different material, a core 150, an annular intermediate layer 151, and an outer (casing) layer 152, preferably of a dough-based material. In order to produce the multi-layered strand 154, the body 153 is provided with two co-axial conduits 155, 156 which have outlet ends 157, 158 respectively which are substantially in the plane of the front face 159 of body 153, the conduits 156 being longer than conduit 155 to enable the axially-spaced conduit inlets 160, 161 respectively to communicate with axially-spaced inlet chambers 162, 163 respectively.

It will be appreciated that although two rotors and three die bodies have been described, a modified apparatus may comprise a third rotor and a fourth die body to produce a four-strand product, or further rotors and die bodies.

In another modified apparatus in accordance with the invention a multi-strand intertwined product is produced which comprises strands having the same core material but different encasing materials. In yet a further modified apparatus a multi-strand intertwined product is produced in which the core material of each strand is different and in which the encasing material of each strand is different.

Although the strands have been shown and described as being of circular outline this, of course, need not necessarily be so and the nozzle(s) of each die body may be of any shape or configuration.

1. Apparatus for producing a plurality of intertwined extruded strands (140, 141, 142), comprising first (4), second (5) and third (6) extrusion die bodies, a first rotor (2) and a second rotor (3), and a stator (7) in which the rotors are rotatably mounted about substantially parallel respective axes, and the arrangement being such that in use one of the rotors is caused to rotate and in so doing engages with two of the die bodies to rotate said two die bodies about the axis of said one rotor, and rotation of the other rotor similarly causes two of the die bodies to be rotated about the axis of that other rotor, and in which each die body is provided with a conduit (28, 28′, 28″), and each conduit comprises an inlet (41, 43) and an outlet (110, 111, 112), the inlets of the conduits being axially spaced from one another in the direction of the axes of the rotors, and said inlets being in communication with respective supply chambers (100, 101).

2. Apparatus as claimed in claim 1 in which the chambers (100) are separated from one another so as to substantially prevent material entering the chamber from another chamber.

3. Apparatus as claimed in claim 1, in which the chambers (100) are axially spaced with respect to the axis of rotation of the rotors (2, 3).

4. Apparatus as claimed in any preceding claim in which the chambers (100) are defined by surfaces of the stator (7), the die bodies (4, 5, 6) and the rotors (2, 3)

5. Apparatus as claimed in claim 2, in which the die bodies (4, 5, 6) and the rotors (2, 3) are of generally elongate form, and aligned surface portions of the die bodies, the rotors and the stator (7) define the three axially spaced chambers (100).

6. Apparatus as claimed in any preceding claim which comprises a partition (130, 131, 132) which axially separates one chamber from an adjacent chamber.

7. Apparatus as claimed in any preceding claim in which the outlets (110, 111, 112) are substantially diametrically located about the axis of rotation of a respective rotor (2, 3).

8. Apparatus as claimed in any preceding claim, in which at least one of the die bodies (4, 5, 6) is provided with a second conduit inlet (106) and a second conduit outlet (30), the second conduit outlet being arranged in or adjacent to the outlet of said conduit whereby in use a co-extruded strand of material issues from said co-arranged outlets, said second conduit inlet communicating with a second conduit chamber (101).

9. Apparatus as claimed in claim 8, in which said conduit outlet (110, 111, 112) is surrounded by said second conduit outlet (30) whereby the material from said second conduit chamber (101) encases material flowing from said conduit (28, 28′, 28″), in the co-extruded strand (140, 141, 142).

10. Apparatus as claimed in claim 9, in which each die body (4, 5, 6) is provided with a respective inlet (106) communicating with said second conduit chamber (101), whereby co-extruded strands (140, 141, 142) of material can be extruded by each die body, and the encasing material for each strand is supplied from the common second conduit chamber.

11. Apparatus as claimed in any preceding claim in which at least one of the die bodies (4, 5, 6) is provided with second (155) and third (156) conduits and the outlets of the three conduits are co-arranged, either adjacent to one another or one within another.

12. Apparatus as claimed in claim 11 in which the three outlets (30, 156, 157) of the three conduits (153, 155, 156) of the at least one die bodies (4, 5, 6) are substantially circular outlets and are arranged substantially co-axially of one another, whereby a strand can be produced which is made up of a central core (150) encased by concentric annular layers (151, 152) of two different materials.

13. Apparatus as claimed in claim 11 or claim 12 in which the inlets to the first (153), second (155) and third (156) conduits communicate with respective chambers that are disposed at different axial positions from one another.

14. Apparatus as claimed in any preceding claim in which the die bodies (4, 5, 6) are of a substantially lenticular transverse cross-sectional profile, the rotors (2, 3) being provided with recesses of complementary cross section to accommodate the die bodies, and the curvatures of the lens faces of the die bodies corresponding substantially to the curvature of the cylindrical surfaces of the rotors.

15. Apparatus as claimed in any preceding claim in which the rotors (2, 3) are of a substantially biconcave transverse cross-sectional profile.

16. An intertwined extruded product which is produced by the apparatus as claimed in any of claims 1 to 15.

17. A product comprising at least three plaited extruded strands, at least one of the strands comprises an outer casing and a core, the casing surrounding the core.

18. A process of producing a product comprising a plurality of extruded plaited strands (140, 141, 142), the process comprising operating apparatus which comprises first (4), second (5) and third (6) extrusion die bodies, a first rotor (2), a second rotor (3) and a stator (7), each extrusion die body comprising a conduit which is provided with an outlet, the process further comprising arranging that material is fed into each conduit (28, 28′, 28″) at respective locations which are spaced from one another in the direction of the axes of rotation of the rotors.
